(19) United States
(12) Patent Application Publication
(10) Pub. No.: US 2004/0238108 A1
(43) Pub. Date: Dec. 2, 2004

(54) Squeeze loops and method for making the same

(76) Inventors: Kung-Tai Liang, Changhua City (TW); Chang-I Lin, Taoyuan City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/623,630

(22) Filed: Jul. 22, 2003

(30) Foreign Application Priority Data
Jun. 2, 2003 (TW) 092114871

(51) Int. Cl. B65H 81/00; B31C 1/00

(52) U.S. Cl. 156/193

(57) ABSTRACT

A method for making a squeeze loop includes step of preparing pre-preg yarns and wrapping the yarns to a mandrel; step of solidifying the yarns and removing the mandrel from the yarns which forms a tube; step of cutting the tube into loops, and step of wrapping the loops with an outer layer made of flexible material.

### FIELD OF THE INVENTION

The present invention relates to a squeeze loop and a method for making the same. The loop has no pre-stress when it is not squeezed so that it bears larger stress during operation.

### BACKGROUND OF THE INVENTION

A conventional squeeze loop is disclosed in FIG. 1 and generally includes a composite material such as glass fiber made plate which is bent to be a loop 10′ and two holding grips 20′ are connected diametrically to the loop 10′. The plate extends through the first grip on the left of FIG. 1 and the two ends are positioned in the grip on the right by two bolts. The plate 10′ is a straight plate which is bent to be the loop so that there is a pre-stress in the plate 10′ before it is squeezed. As shown in FIG. 2, when squeezing the loop at two points “P” and “H” inward, the two points “A” and “O” are deformed at a large scale so that the two points “A” and “O” are suffered by a large stress and could crack. When the two points “P” and “H” are pulled outward, the two ends secured by bolts could split from the grip and hurt the user.

The present invention intends to provide a squeeze loop and a method for making the same, wherein the loop is made by wrapping pre-preg yam to a mandrel such that there is no pre-stress on the loop and the loop may bear larger stress when being squeezed.

### SUMMARY OF THE INVENTION

In accordance with one aspect of the present invention, there is provided a method for making a squeeze loop and the method comprises the following steps:

step 1: preparing pre-preg yarns and wrapping the yarns to a mandrel;

step 2: solidifying the yarns and removing the mandrel from the yarns which forms a tube;

step 3: cutting the tube into loops, and

step 4: wrapping the loops with an outer layer made of flexible material.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 shows a conventional squeeze loop;

FIG. 2-1 shows points on the conventional squeeze loop;

FIG. 2-2 shows when the conventional squeeze loop is squeezed by “F”, the two points “A” and “O” are deformed;

FIG. 3-1 is a perspective view to show the squeeze loop of the present invention;

FIG. 3-2 is a cross sectional view to show the squeeze loop of the present invention;

FIG. 4 is a flow chart of the method of the present invention;

FIG. 5-1 shows yarns are wrapped around a mandrel;

FIG. 5-2 shows the two parts of the mandrel is separated and removed from the solidified yarns;

FIG. 5-3 shows the tube formed by the solidified yarns is cut into loops;

FIG. 5-4 shows the loop cut from the tube;

FIG. 5-5 shows that each loop includes an inner layer and an outer layer;

FIG. 6-1 shows the points on the loop of the present invention;

FIG. 6-2 shows the two points “A′” and “O′” of the loop of the present invention when the loop is squeezed;

FIG. 7-1 shows the relationship of deformation and the points of the loop of the present invention when the loop is squeezed;

FIG. 7-2 shows the relationship of deformation and the points of the conventional loop when the conventional loop is squeezed;

FIG. 8-1 shows pre-stress applied to the conventional loop, and FIG. 8-2 shows the force squeezes the conventional loop.

### DETAILED DESCRIPTION OF THE PREFERRED EMBODIMENT

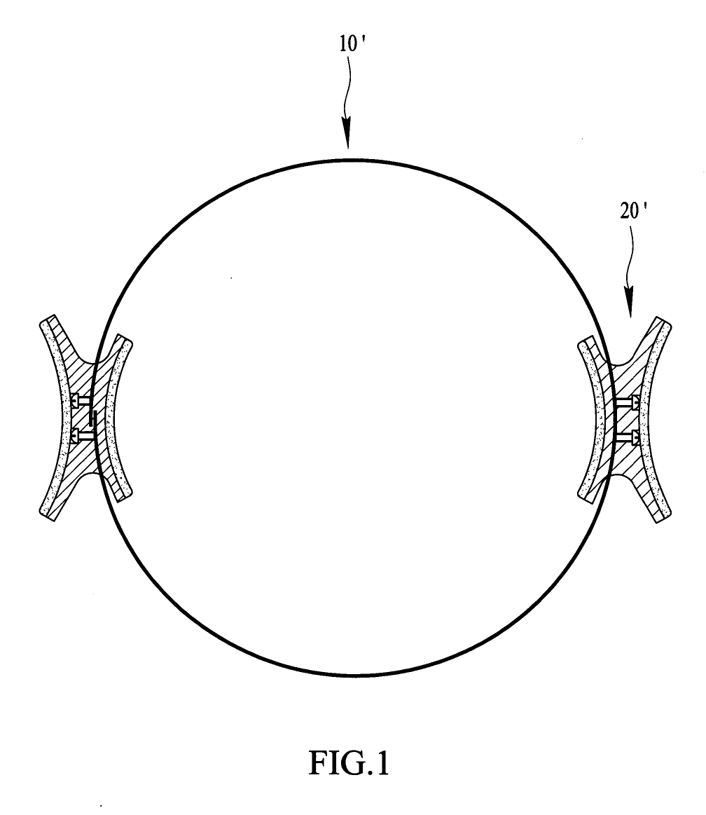

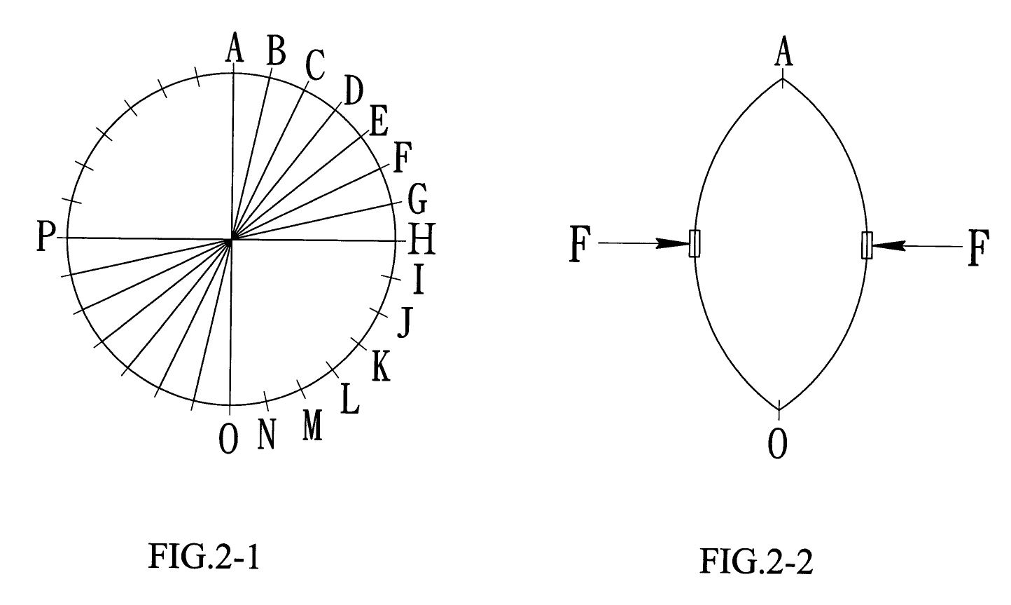

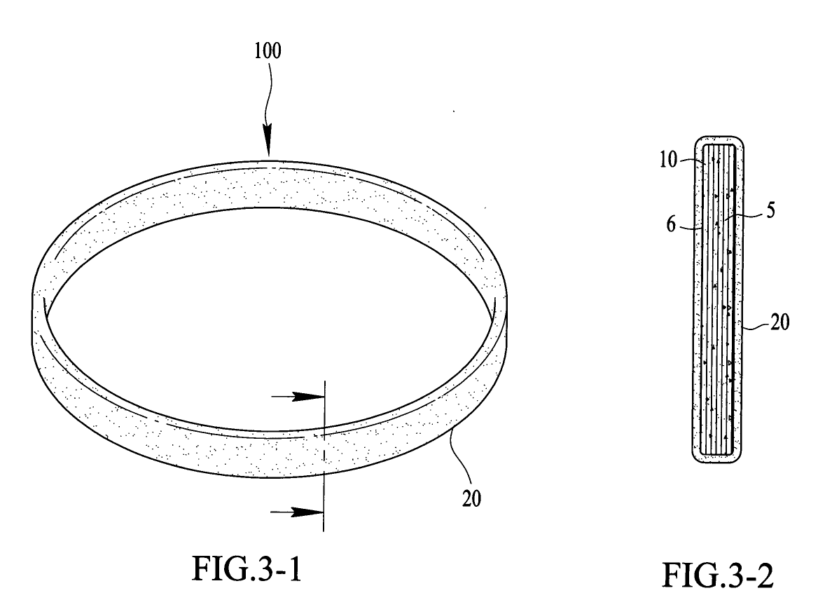

Referring to FIG. 3-1 and 3-2, the squeeze loop of the present invention comprises an inner layer 10 made of yarns 5 merged in thermo-plastic or thermo-setting resin and an outer layer 20. The outer layer 20 is made of flexible material such as foam material, plastic or rubber. The inner layer 10 of the loop is formed integrally without pre-stress. The outer layer 20 may be made to have desired shape such as a wave-shaped and colors.

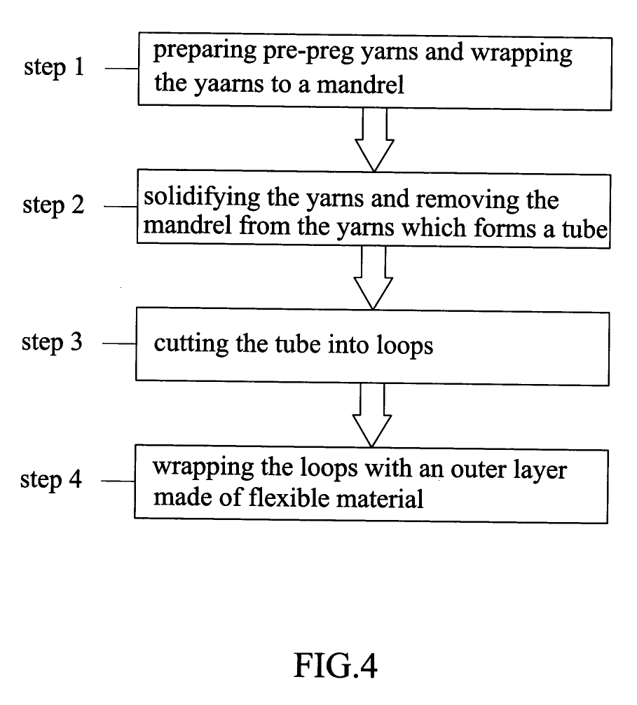

FIG. 4 shows the method for making the squeeze loop of the present invention and the method comprises the following steps:

step 1: preparing pre-preg yarns 5 and wrapping the yarns 5 to a mandrel 7;

step 2: solidifying the yarns 5 and removing the mandrel 7 from the yarns 5 which forms a tube 50;

step 3: cutting the tube 50 into loops 100 with desired width, and

step 4: wrapping the loops 100 with an outer layer 20 made of flexible material such as foam material.

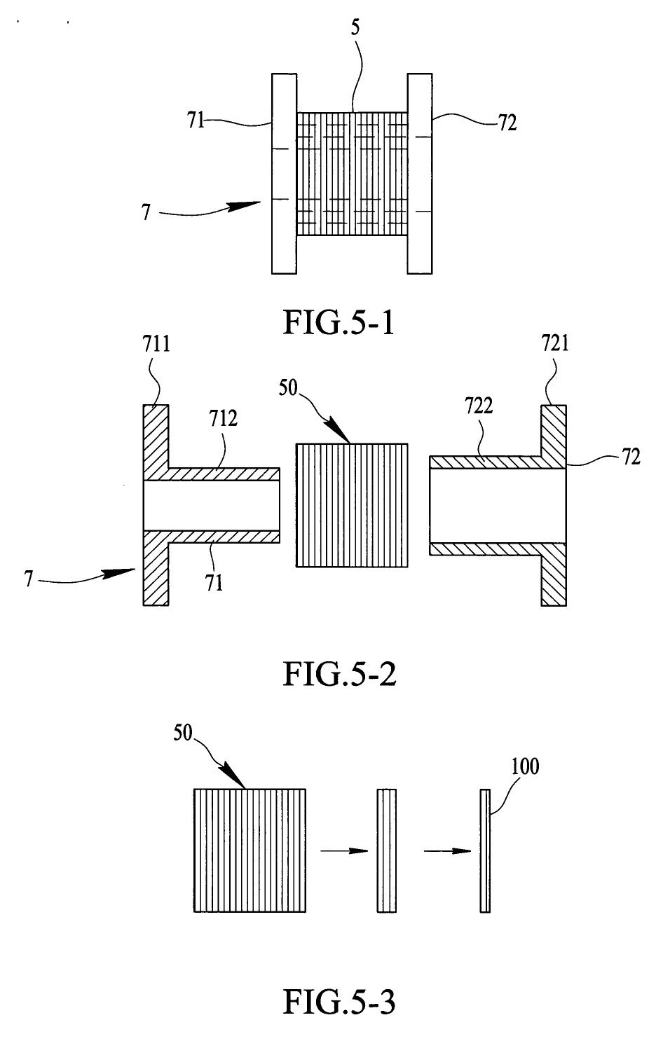

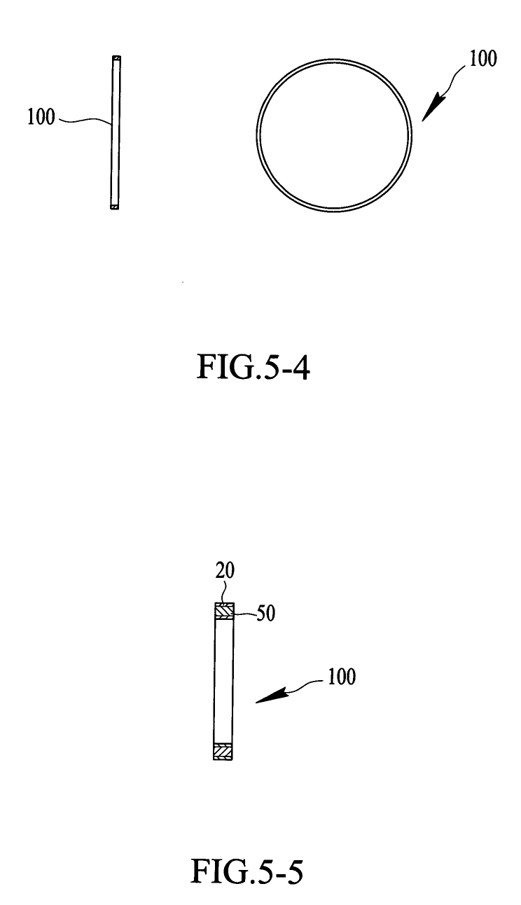

As shown in FIGS. 5-1, 5-2 and 5-3, the mandrel 7 includes a first part 71 and a second part 72. The first part 71 has a first tubular section 712 and a first flange 711 on a first end of the first tubular section 712. The second part 72 has a second tubular section 722 and a second flange 721 on a first end of the second tubular section 722. The first section 712 is removably inserted in the second tubular section 722, such that when the wrapped yarns 5 is solidified, the two parts 71, 72 are separated from each other so as to have the tube 50. FIGS. 5-4 and 5-5 show the composition of the loop 100.

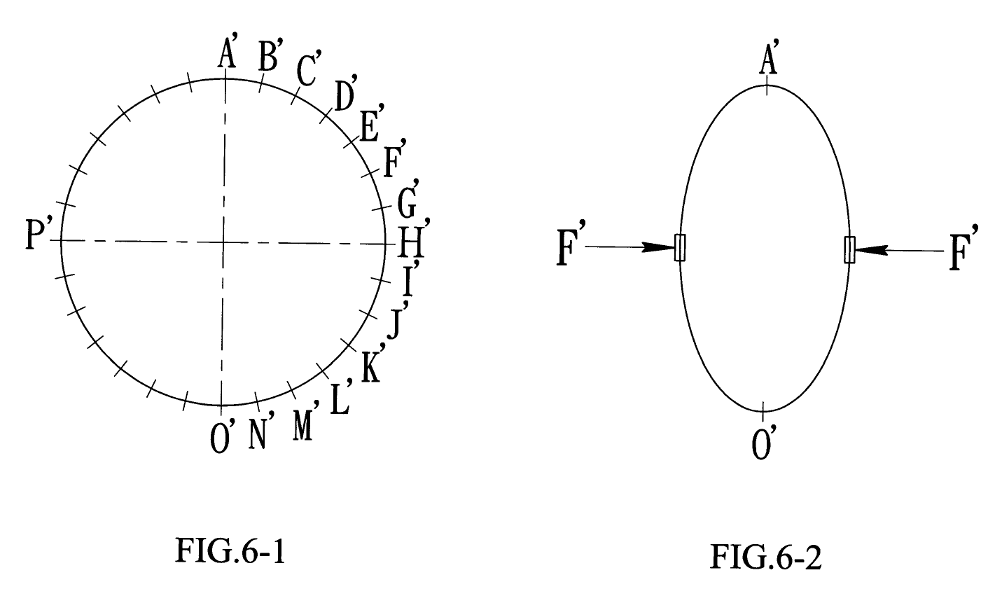

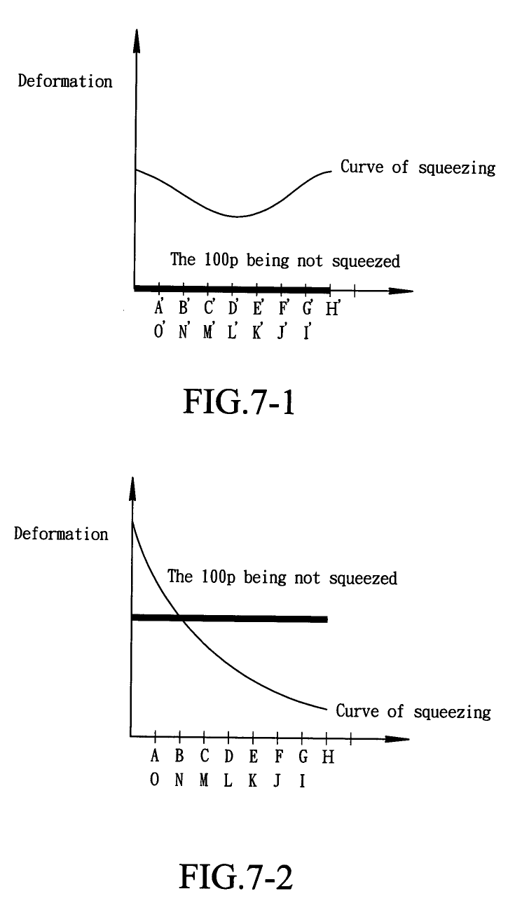

Referring to FIGS. 6-1 and 6-2, because the loop 100 of the present invention is formed by the solidified yarns 5 so that no pre-stress is applied to the loop 100. When the loop 100 is squeezed by two forces “F′” in opposite directions as shown, the two points “A′” and “B′38 are deformed. Referring to FIG. 7-1, the curve of the relationship between the deformation of all the points A′ to O′ is a smooth concave curve.

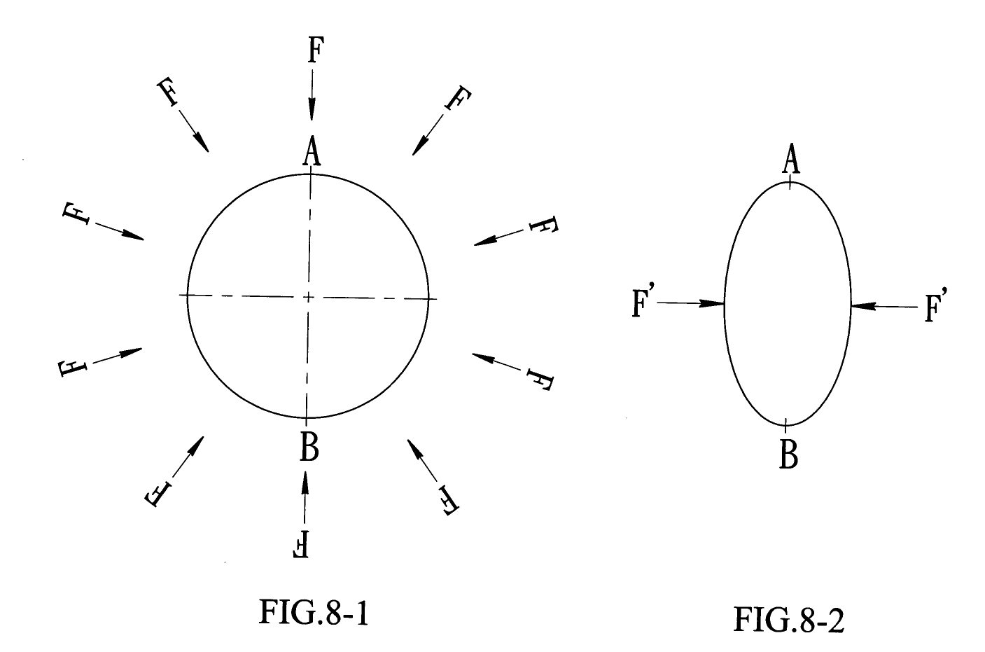

Referring to FIGS. 8-1 and 8-2, the conventional loop is made by bending the plate into a loop, so that a pre-stress F is existed in every point in the conventional loop. When two forces F′ squeeze the conventional loop, the points “A” and “B” are suffered by the sum of the forces “F” and “F′”. Therefore, the conventional loop tends to crack.

While we have shown and described the embodiment in accordance with the present invention, it should be clear to those skilled in the art that further embodiments may be made without departing from the scope of the present invention.

What is claimed is:

1. A method for making a squeeze loop comprising:
step 1: preparing pre-preg yarns and wrapping the yarns to a mandrel;
step 2: solidifying the yarns and removing the mandrel from the yarns which forms a tube;
step 3: cutting the tube into loops, and
step 4: wrapping the loops with an outer layer made of flexible material.

2. The method as claimed in claim 1, wherein the mandrel includes a first part and a second part, the first part has a first tubular section and a first flange on a first end of the first tubular section, the second part having a second tubular section and a second flange on a first end of the second tubular section, the first section removably inserted in the second tubular section.

3. The method as claimed in claim 1, wherein the outer layer is made of foam material.

4. A loop comprising:
an inner layer made of pre-preg yarns and an outer layer, the outer layer being made of soft material, the inner layer of the loop being formed integrally without pre-stress.

5. The loop as claimed in claim 4, wherein the outer layer is made of foam material.

6. The loop as claimed in claim 4, wherein the outer layer is made of rubber.

7. The loop as claimed in claim 4, wherein the outer layer is made of plastic.
